(19) United States
(12) Patent Application Publication
(10) Pub. No.: US 2014/0077648 A1
(43) Pub. Date: Mar. 20, 2014

(54) ELECTRIC WINDING FOR ELECTRIC ENERGY CONVERTERS OR MACHINES, METHOD FOR MANUFACTURING SAME AND ELECTRIC MACHINE

(71) Applicant: Technische Universitat Chemnitz, Chemnitz (DE)

(72) Inventors: Patrick BRÄUER, Chemnitz (DE); Johannes RUDOLPH, Bad Lausick (DE)

(21) Appl. No.: 14/027,805

(22) Filed: Sep. 16, 2013

Related U.S. Application Data
(60) Provisional application No. 61/701,885, filed on Sep. 17, 2012.

(51) Int. Cl. H02K 3/26; H02K 3/34; H02K 15/04; H02K 3/02

(52) U.S. Cl. CPC H02K 3/26; H02K 3/02; H02K 3/34; H02K 15/0407
USPC 310/152; 310/179; 29/596

(57) ABSTRACT

A winding is provided for electric energy converters, such as electric machines, like electric motors, generators or transformers, and a respective machine. The winding has conductor paths applied to a flexible carrier material by means of a printing process, in particular screen printing process. The conductor path preferably includes an electrically conductive paste. The conductor paths are printed one above the other in layers, and an insulating layer is applied between individual layers of the conductor paths. The conductor paths are arranged such that the conductor paths of superimposed winding layers preferably are transversely shifted against each other in a pre-finished, rolled up state.

### CROSS-REFERENCE TO RELATED APPLICATION

This application claims the benefit of U.S. provisional patent application 61/701,885, filed Sep. 17, 2012, the disclosure of which is incorporated herein by reference.

### BACKGROUND OF THE INVENTION

The present invention relates to windings for electric machines or energy converters on the basis of electro-magnetic force, energy converters produced therefrom, and a method for their manufacturing. Electric energy converters or machines are in particular understood as being rotary or translatory electrical machines on the basis of electric and/or magnetic fields as well as magnetic supports and electric or electromagnetic converters, respectively. Electrically conductive windings occur in particular in the form of armature windings, field windings, phase windings, cage windings or damper windings. The invention also refers to a method for manufacturing such electric winding and for mounting same and to an electric machine having such a winding.

The invention may be useful also for manufacturing other electric components, such as capacitors or other electric elements.

Conventional windings for electric energy converters or electric machines, such as rotary electric machines, like electric motors or generators or non-rotating electric machines such as transformers are manufactured by means of insulated copper or aluminum wires. Such windings in particular for very small electrical machines result in relatively large air gaps since both the executable current density as well as the realizable winding filling factor are limited. This in turn leads to a higher magnetizing current demand and thus to a reduced degree of efficiency and to a larger overall installed size. A further disadvantage is that these windings are arranged statically around their respective carrier element and repairs in the event of damage (burning out of a coil) are only possible with great effort or not at all.

To solve the above problems mentioned, prior art proposed windings, which are arranged on flexible carrier materials and can for installation be rolled up and inserted into the housing of the energy converter.

For this purpose, the use of copper-clad films for production of electrical windings is well established in the art. In this, the winding is produced by lamination, where a conductive and an insulating structure is alternately applied to a substrate. The layer thickness of substrate and copper-cladding and protective layers resulting for the coil is typically several 100 μm. A disadvantage of this solution is comparatively high production costs and the limited bending radius of the winding due to a relatively high mechanical rigidity. This limited bending radius is particularly detrimental for windings for small energy converters which require very small bending radii due to their design.

### BRIEF SUMMARY OF THE INVENTION

The object of the present invention is to provide an electric winding for electric energy converters or electric machines that is inexpensive in production and can be manufactured with electrical conductors which are subject to very small radii as is required, i.e. for micromotors and, thus, which is suited for small electrical machines with small dimensions and to provide such an electric machine having a compacted design which establishes a high current density of its conductors. Another aspect of the object is to provide a method for manufacturing an energy converter such as an electrical motor with a winding according to the present invention.

The object is achieved according to the invention for the winding, for the electric energy converter, and for the method, as well as for the electrical machine, as described and claimed below.

Advantageous further developments are also described and claimed.

Accordingly, the present invention provides an electrical winding for electric machines or electric energy converters on the basis of the effects of electromagnetic forces, wherein said winding comprises a plurality of electrical conductor paths applied to a carrier material by means of a printing process in conjunction with a layer of insulating material covering said conductor paths.

Preferably, said electrical winding comprises a conductor path applied to a flexible carrier material, such as a film made of synthetic resin, like a thermo-plastic film, and said conductor paths are in particular applied to said flexible carrier material by means of a printing process, most preferably by a screen printing process. According to another preferred embodiment of the present invention, said conductor paths are directly printed onto a carrier material of rotational symmetry design, such as a sleeve or hollow cylinder, and are preferably screen-printed in multiple layers and alternating with insulating layers printed in between and serving as dielectric. Thus, that insulating layer, preferably screen-printed as well, on the one hand, serves for the layer insulation of the respective winding layer of conductor paths in follow-up layers but also for conductor isolation of the conductor path within the same layer.

Moreover, thinner film thicknesses than with the use of copper-clad films for the same current linkage can advantageously be achieved by means of screen-printed windings. In addition, smaller bending radii of less than 2 mm and, depending on the chosen substrate, high temperature stability are achievable. Examples of applications for windings according to the invention are armature, field, phase, cage or damping windings.

Advantageously, the conductor paths are produced from electrically conductive paste or ink. For example, this paste can comprise a silver content. However, other metals or alloys determining the conductivity of the paste are possible. The amount of conductive particles is also crucial for the maximum possible current density.

The conductor paths can be printed with paste creating different conductivities for the resulting conductor paths. Since typically particularly highly conductive pastes are significantly more expensive than less conductive ones, it is possible to create windings of the same dimensions having differing properties (e.g. different magnetic field strengths). In this manner, the windings can be adapted to the actual technical requirements.

Preferably, during the multi-layer manufacturing of the winding from single layers or winding layers of separated printed conductor paths after printing a winding layer or layer of conductor path and/or a dielectric insulating layer, a drying or curing, in particular ultra-violet curing of the pasty print is performed. Occasionally, also the finally manufactured multi-layered winding is finally subject to a drying or curing process under heat treatment. This, in addition to a mechanical stabilization, leads to an increase of the electric conductivity of the conductor path resulting from the vaporization of the non-conductive organic constituents or components of the conductive paste which leads to an increase of the conductive particles or the silver amount within the conductor paths so that the electric conductivity increases.

Within the subject of this application under “printing” also jet application, for example by jetting conductor paths onto a carrier material by means of a conductive fluid, such as conductive ink, should be understood. Also, a combination of screen-printed conductor paths with conductive ink jetted dielectric insulating layers is possible.

Printing on the carrier material can be effected on one or two sides and in several layers.

In order to insulate several printed layers from each other, an electrically insulating layer, preferably a dielectric is printed between the electrically conductive layers. For reducing the resulting layer thickness of the winding and for preventing unnecessary layer height, conductor paths can advantageously be printed in a shifted or offset manner. In this, a better winding filling factor is achieved than for layers printed in a superimposed manner with conductor paths directly printed one above the other in follow-up layers and separated by an insulating layer, without having to increase the width of the conductor paths. This means practically the conductor paths do not lay in a superimposed way directly one above the other (repeated by an insulting laser) but one aside the other, when considering a projection thereof.

Accordingly, the conductor paths within one layer or winding layer are offset laterally (or axially when considering a wound condition) with respect to the conductor path in a subsequent layer of the winding.

Preferably, the winding comprises four layers printed on each other: as first layer a supply conductor of the conductor path printed on the carrier material, as second layer an insulating layer (dielectric), as third layer a return conductor of the conductor path, and as fourth and final layer an insulating and protective layer, wherein the first and third layer are connected through an interlayer connection.

Said interlayer connection is preferably established either by small winding heads or tongues which continue the respective conductor paths which project over the insulating layer (dielectric) and which serve for the electrical connection of the supply and return conductors. Alternatively, said interlayer connection is established by through-holes penetrating the insulating layer which form areas of through contacting when the follow-up conductor path is printed so as to establish a through contacting between the conductor paths of the supply and return conductors.

A printed, in particular screen printed winding structured in this way can be used in small power electrical machines, such as machines having an outside diameter of about 40 mm and length of the machine of about 80 mm, in particular three phase synchronous motors or generators. One large advantage of such screen printed windings is the much smaller geometry in comparison to those of conventional wire windings for motors or generators. However, it is possible to reach similar ampere-turns. The reason is the high current density of up to 100 A/mm² the screen printed winding can be used with. What makes this possible is the proportion of cross-sectional area to surface that is responsible for much better heat dissipation.

The imprinted conductor paths can be arranged in straight rows or in rhombus form. They can also have an involute or elliptical shape. By such an involute or elliptical conductor arrangement a significantly reduced ohmic resistance can be achieved for generating the same power.

The conductor paths cannot only be printed onto a flexible film which is formed thereafter into a hollow cylinder or can be formed helically for other electrical components or windings but, in a roll-to-roll printing procedure, also a sleeve-like or hollow-cylindrical-shaped form body can be used or can act as the support of the printed winding which, preferably, is a multi-layered winding with dielectric interlayers in between.

In a preferred embodiment, the carrier element is a PET film. It has high strength and dimensional stability even at higher temperatures. Depending on the application, however, other materials are also preferred, PEN or PEEK are for instance also usable with even better temperature stability than PET.

In particular, the screen printing can be applied on a carrier material made of ceramic, for example a ceramic foil. Due to the thereby increased operating temperatures the electrical properties of the windings can be positively influenced. In other words, due to the increased heat resistance of the unit winding (total winding or coil) as well as by means of the higher drying and hardening temperatures during its manufacture or thereafter which can be achieved hereby higher operating temperatures of the windings can be allowed. By means of that, the electrical properties of the windings can be improved, in particular by means of the increase of the content of the electrically conductive particles within the winding print achieved by increased evaporation of the non-conductive constituents as well as by means of the possibility to make use of higher drying and hardening temperatures, leading to an increase in electric conductivity of the winding.

The carrier material made of plastic or ceramic is preferably formed as a prefabricated molding, for example, a sleeve. The printing on such a formed body can be done by roll-to-roll printing. The direct printing of the winding onto the formed body contributes to a further reduction in the number of steps in the manufacturing and assembly processes of the winding as, for example, the late forming of a hollow cylinder from a film support body (formed body) which is initially subject to be printed as a flat element can be dispensed with.

Preferably, the windings of the present invention can have bending radii of less than 2 mm.

In a further preferred embodiment, the conductor paths of the winding are arranged such, that in the ready-to-install, rolled-up state, the conductor paths of the superimposed winding layers are transversely shifted against each other. This means, that in the roll-up state, the conductor paths of superimposed winding layers engage in a tooth-like manner. This results in the winding having smaller outer dimensions.

Preferably, the axial beginning and/or ends of the winding comprise contact tabs for electrical contacting. In this, the contact tabs are axially projecting areas of the carrier material with imprinted conductor paths. As a result, the winding can be easily connected.

Preferably, the winding, i.e. the conductor paths, is provided with a galvanic coating, for example, of copper. This leads to an improvement of the conductivity and has also a significant positive impact on the efficiency and winding power per unit volume.

Preferably, the winding is designed in multiple strands, i.e. multi-phased, in particular embodied in three phases and provided with the respective contacts and connectors for the single phases, i.e. for each winding strand.

The electric energy converter according to the invention on the basis of electromagnetic force comprises a winding according to the invention produced by means of a printing process, preferably a screen printing process. In this manner, the dimensions and the mass of the energy converter can be reduced considerably compared with prior art, which is relevant in particular for applications in medical technology, space technology and model making

With the low production costs and the easy way of assembly, such a printed, in particular screen printed winding in electrical machines and other energy converters is an interesting solution for small motors which are demanded in high production quantities and a small power-range of some milliwatts to some watts.

A major element (e.g., stator) of an electrical machine or of an electric energy converter can be equipped with windings suitable for different applications and can be used at a reasonable price. Moreover, changing the windings for different requirements can result in the fact, that an existing main element of an electrical machine, such as a motor, or of an electric energy converter can still be used in that only a winding is inserted which is more suitable for the requirements. In the event of damage, a blown winding can be easily exchanged by simple replacement.

In a preferred embodiment, contacting of the winding is effected by contact tabs, which are fixed by means of a contact plate. The contact plate can there be formed as an axial cover for the winding. Particularly preferably, the contact plate comprises counter contacts with springy elements, which when assembled press against the contact tabs of the winding and thus create the contact. Elements clasping the contact tab are also possible instead of the springy elements. It is possible, through contacting by means of springy or clasping elements, to create a flat bandage-like interconnection between the connection lines and the conductor paths of the winding. By means of this surface contact, the current density at the contact point can be kept low.

In a further preferred manner, the contact plate secures the radial and/or axial position of the winding. Assembly of the energy converter can thus be achieved in a very simple and inexpensive manner, because contacting or securing the winding is performed in one step together with closure of the housing.

In a further preferred embodiment, a printed winding according to the invention is used in the energy converter for electrical and magnetic shielding of sensitive components and conductor paths. For this, the printing may also be in area or lattice structures.

The method according to the invention for manufacturing a winding as previously described comprises the following steps:

First, parameters such as the required number of strand wrappings, strand winding member and the necessary conductor cross-section are calculated. Crucial for this is the power and torque characteristics required by the electrical machine or energy converter to be manufactured.

The winding geometry is then determined. This applies to dividing the winding into several winding levels or layers (planes), where a possible above-mentioned transversal shift of the conductor paths of superimposed winding layers is provided with the aim of reducing the total layer thickness and of the reduction of the outside diameter of the winding in total.

Printing is performed after provision of the carrier material and a screen (or a plurality thereof) having a structure corresponding to the conductive and insulating layers to be printed. Following every printing process, the printed layer must dry before another one can be applied. Conductor paths and insulating layers are alternately applied until the desired number of conductor paths is printed.

For accelerating the stabilization of the printed conductive paths and the dielectric, respectively, it can be advantageous to perform the printing process onto a carrier material at elevated surrounding temperatures or to warm-up the carrier material, i.e. a formed body or a flexible carrier film, under consideration of the heat resistance of the carrier material (plastic or ceramics) and of the operating temperature determined by the nature of the carrier material.

In the method of manufacturing the winding, through-contacting is preferably created between the individual conductor paths by specific recesses when printing the insulating layer (dielectric).

By means of the recess in the insulating layer, an electrical connection is achieved between the conductive levels (winding layers) when printing the next conductive layer by filling the recess with conductive paste.

Preferably, the imprinted conductor paths are coated by galvanization with a thin film, in particular a film of copper. This contributes to a significant progress in reducing the ohmic losses.

On the other hand the possibility exists to apply a final heat treatment to the winding. This heat treatment is thought to evaporate the last remaining fractions of organic compounds in the winding. As consequence of the achieved evaporation of the organic binder contents, the structure of the electrically conductive paste (e.g. silver paste) of the imprinted conductor path is homogenized. The result is a significantly reduced ohmic resistance.

In other words, by means of a controlled heat treatment (also considering the current-heat resulting evaporation of organic constituents of the conductive paste or ink which form the conductive paths) the conductivity can be increased. Also, the finished winding or coil can be subjected to a heat treatment. As a result of the evaporation of organic binders achieved that way, the structure of the electrically conductive paste, i.e. silver paste or ink, of the imprinted conductor paths is homogenized. The resulting significant reduction of the ohmic resistance can lead up to the range of conventional conductors made of copper.

The advantage of low manufacturing costs of such imprinted windings for electrical machines or energy convertors, thus, can be further enhanced.

This advantageous effect can be controlled and regulated through a specific heat treatment. After such a specific heat treatment the winding has a defined ohmic resistance which does not change with further heating.

The method according to the invention for installing the winding according to the invention into an electric energy converter comprises the following steps:

In a first step, the winding is brought into the required geometric shape, which is predetermined by the dimensions of the respective main element carrying the winding. The main element carrying the winding is presently, for example, the rotor or the stator of the energy converter. The inner diameter of the stator or the outer diameter of the rotor, respectively, determines the shape.

In a second step, fixation of the desired winding shape is effected by means of direct positive-fit or force-fit methods, such as e.g. bonding, welding or clamping. Alternatively, indirect fixation is effected by means of an apparatus which corresponds to the shape of the main element carrying the winding.

In the third step, introduction of the fixed winding into the main element carrying the winding is performed, where the winding is fixed into position by suitable fittings, such as a stop or guide rails. Preferably, fixation of the winding is performed by the contact plate.

Advantageously, prefixed windings are already provided which, when requirements change or in the event of damage, are simply replaced by exchanging the existing winding.

The electrical machine of electric energy converter comprising such a printed, in particular screen printed winding can, in particular, be a small rotation drive device, more particularly a three-phased, a symmetrical rotating electric motor or generator. In contrast to conventional motors or generators, smaller air gaps, reduced winding dimensions and higher current capabilities can be achieved by means of printed, in particular screen printed windings. Thus, high power densities in relation to volume and mass of such a small motor or generator can be obtained. Moreover, it is possible to use such motors or generators under high humidity or in vacuum.

It is also possible to manufacture a rotor from a permanent magnet, i.e. NdFeB, with a rotating magnetic back iron, i.e. a pot-shaped magnetic circuit closing element is fixed onto the shaft of the permanent magnet and rotates therewith. Thus, the magnetic field created by the permanent magnet of the rotor closes via the pot-shaped ferromagnetic back iron element, preferably a ferromagnetic body, which rotates together with the permanent magnet so that same is in relative rest thereto.

This is advantageous in that re-magnetization losses of the exciter field (permanent magnet) are cancelled within the magnetic back iron (stator). A lamination of the ferromagnetic back iron, thus, is not required. While, by means of that, the volume of the structure is enlarged somewhat, on the other hand, the starting behavior is improved, which is important just for such small electrical machines. Resting moments, in this way, are drastically reduced or suppressed. A magnetic decoupling between the magnetized back iron element and the permanent magnet on the rotor shaft can be advantageous.

Thus, the electric energy converter in form of a motor advantageously comprises a pot-shaped back iron, preferentially with NdFeB magnets, for excitation of the winding. The pot-shaped form of the back iron for closing the magnetic circuit has the advantage of allowing the iron back to rotate so that re-magnetization losses and detent torques are reduced significantly.

In this way, two air gaps arise, one between the winding and the permanent magnet of the rotor and one between the winding and the magnetic back iron (magnetizable iron element), wherein the hollow-cylindrical coil or winding, preferably, is seated (accommodated) onto a flange or winding shape-adapted projection or a bearing or supporting structure, i.e. an annular projection of a cover or lid plate (contact plate) of the motor.

In case of other embodiments having a conventional stator, the winding can preferably be bonded to the interior surface of the stator with or along its outer circumference.

Within the framework of such an energy converter comprising a printed, in particular screen printed winding, within an integral process step all components necessary for the operation of the converter (such as electrical machine, like motor or generator), such as the necessary control electronics or circuiting as well as electronic evaluation circuiting and power electronics are printed, in particular screen printed in a joint manufacturing process with the imprinting of the winding. As a result, imprinted and disposed onto the carrier material is preferably not only the winding but also the control, evaluation and power electronics.

In the method according to the invention for manufacturing an electric energy converter comprising a winding produced by means of a screen printing method, parts of the control, evaluation, and power electronics necessary for operation are produced in a joint process with the electrical winding using screen printing methods. As a result, parts of the control, evaluation, and power electronics necessary for operation are also disposed on the carrier material in addition to the winding.

According to the invention a further method for manufacturing a winding comprises the following steps: printing the supply conductor of a conductor path on a carrier material; printing a first insulating layer onto the supply conductor; printing the return conductor of a conductor path onto the first insulating layer such that an electrical connection is formed between the supply and return conductor; printing a final second insulating layer onto the return conductor in order to protect the winding against mechanical wear.

Thus, the present invention relates to an electric winding for electric machines or energy converters on the basis of electromagnetic force, wherein a plurality of electrically conductive paths are printed onto a carrier material in conjunction with a layer of insulating material covering the conductive paths. Preferably, the winding comprises an assembly of electrically conductive paths in at least two layers with dielectric insulating material between the layers of conductive paths. Preferably, the layer of insulating material between successive layers of conductive paths is simultaneously a layer of insulting material which isolates and/or separates the conductive paths within one layer while, particularly the conductive path and/or the layers of insulating material are printed, in particular screen printed.

Preferably, the carrier material is a flexible carrier film made of plastic or synthetic resin or thermo or duroplastic material, in particular PET, PEN or PEEK. According to a preferred embodiment of the present invention, the electrically conductive paths are printed from an electrically conductive fluid, in particular an electrically conductive paste, preferably silver paste. The conductive paths are preferably provided with an electrically conductive coverage or coating, in particular made of copper and are preferably metallized or galvanized. A preferred design of the winding comprises the conductive paths with one layer to be provided in straight rows or in a rhombus-like pattern.

According to another preferred embodiment, the conductive paths are designed within one layer in a curved, in particular from a pattern of involutes, parabolas or ellipses. By means of predetermined heat-treatment or under the influence of the current flow within the conductive paths leading to a respective warming up of the winding, the conductive paths comprise a reduced ohmic resistance.

According to another preferred embodiment, the carrier material is made of ceramics. The carrier material may form a tube or sleeve-shaped body onto which the conductive paths are printed, in particular screen printed. The carrier material is preferably a resilient carrier film made of plastic or synthetic resin material which is printed, preferably screen printed, as a substantially plane element. Thereafter, the printed carrier film is subject to shaping, in particular into a cylindrical shape and forms a solid body in said shape. Preferably, the carrier cylinder is imprinted in multiple layers with a plurality of conductive paths alternating with layers of insulating material, at least along an interior surface or a path thereof. Preferably, the cylinder along its outer surface is bonded to a surrounding stator of an electrical machine, in particular a multi-phase, preferably three-phase electric motor or is connected to the stator by other means. Accordingly, preferably the carrier cylinder is imprinted, in particular screen printed with carrier path along its outer and/or interior surface in multiple layers, wherein the layers and/or the conductive paths within one layer are isolated from each other and/or separated by a layer of a printed, in particular screen printed dielectric.

Preferably, the winding is an air gap winding which is accommodated between a rotor, preferably made of a permanent magnet, and a stator and is attached to the stator or to the rotor and/or at least to an axial end plate of the housing so as to establish an air gap to the rotor and/or to the stator. Preferably, the winding is accommodated at one or, preferably at opposite end plates of a rotating electric machine, in particular by means of an axially and/or radially effective abutment and/or a supporting structure, preferably is radially and/or axially positioned at both opposite end plates of the housing. Preferably, the end plate is a contact plate for electrically contacting of at least one contact tap connected to the winding. According to another embodiment, the contact plate comprises counter-contacts with clamping or springy contact elements.

According to a preferred embodiment of the electric winding, according to the present invention, the conductive paths, a plurality of layers with a layer of insulating material being printed between them, are shifted or offset in a direction of the widths of the conductive paths.

Preferably, an axial or radial end of the winding as a starting of the winding or an end thereof comprises electrical contact taps for the electrical contacting of the winding or such contact taps are connected to a conductive path within the winding. Together with the conductive paths, preferably electrical control and/or evaluation or and/or power electronics are imprinted, in particular screen printed, together with the winding onto the preferably flexible carrier material, together with the conductive paths.

Preferably, the electric winding is a single or multi-phase winding comprising a plurality of layers of conductive paths in a predetermined winding or coil geometry, comprising alternating printed, in particular screen printed layers of conductive paths and layers of insulating material, in particular made of dielectric material, wherein each of the layers of insulating material, after printing, are dried and hardened before another layer of conductive paths is printed thereon.

Preferably, the layer of insulating material between two adjacent layers of conductive paths comprises through-holes by means of which the conductive paths of successive layers thereof separated by a layer of insulating material are connected electrically conductively to each other by through contacting.

Preferably, an electric winding comprises four layers printed one above the above, in particular screen printed, with a first layer of conductive paths as supply conductor, printed onto a flexible carrier film, a second layer comprising a dielectric, a third layer made of electrically conductive paths as current return conductor and a fourth and closing coverage layer as dielectric or isolating protective layer, wherein the conductive paths of the first and third layers are connected to each other electrically conductive by an intermediate electric contact. Said intermediate electric contact has an intermediate electrical connector, preferably is established by connecting of small winding head tabs portions from the current supply conductor and the current return conductor and wherein small winding head portions or tabs project beyond the intermediate layer of insulating material and, preferably, do not contact to said layer of insulating material. The conductive paths are preferably imprinted on both sides of the carrier material, in particular in multiple layers successively and under intermediate incorporation of layers of insulating material in an alternating way. Preferably, the carrier material comprises a tube-shape or helical, cylindrical structure, in particular it is a dielectric.

According to the present invention, it relates also to an electrical machine having a winding structure as indicated above, wherein a rotor comprises a pot-shaped structure between a permanent magnet of a rotor shaft and a pot-shaped ferromagnetic or magnetic back iron element, wherein the winding is designed as air gap winding in a shape of a cylinder and comprising an air gap to both the permanent magnet as well as the ferromagnetic or magnetic back iron. Preferably, the magnetic material of the permanent magnet is a NdFeB magnet element which is separated from the pot-shaped magnetic back iron, preferably by means of a washer made of plastic or synthetic resin between the permanent magnet and the ferromagnetic or magnetic back iron. According to the present invention, said electrical machine preferably comprises a stator and a printed, in particular screen printed multi-layered winding bonded to the stator and comprising a rotor with a permanent magnet attached to a rotor shaft, a cover plate of the housing with an abutment element for the axial and/or radial positioning of both the stator as well as of the winding connected thereto and having an opposite contact plate connected with another abutment for the axial and/or radial affixation of the stator and/or winding and/or the contact plate, wherein the winding comprises radially outwardly standing contact tabs which are in electrical contact with counter contacts of the contact plate at the interior side thereof, said counter contacts are designed as springy elements for establishing electrical pressure contact to the winding.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 shows a sectional view of a layer of the winding with conductor paths arranged in a shifted manner prior to shaping the winding in cylindrical shape;

FIG. 2 shows a sectional view of an electrical motor as a sample of an energy converter comprising a screen-printed winding in partial view (schematically);

FIG. 3 shows a longitudinal section of an electrical motor of FIG. 2 comprising a screen printed winding;

FIG. 4 shows the top view of a contact plate of the electrical motor of FIG. 2;

FIG. 5 shows a layout of the different layers of a rhomb structured winding comprising a first winding layer (supply winding layer) and a second winding layer (return winding layer) in schematic spread view;

FIG. 6 shows a sample of a screen printed three-phase electric winding consisting of the four layers of FIG. 5 printed one above the other;

FIGS. 7a and 7 b show the area of the winding head of an electric energy converter (electrical machine with a conventional winding (FIG. 7a) and a screen printed winding (FIG. 7b));

FIG. 8 shows three geometrical alternatives of a rhomb structured winding according to FIG. 5 and FIG. 6;

FIG. 9 shows the general layout (schematic in longitudinal section) of an electrical machine, such as an electrical motor having a pot-shaped rotor (rotating magnetic back iron); and

FIG. 10 shows the small electrical motor of FIG. 8 in schematic perspective view.

### DETAILED DESCRIPTION OF THE INVENTION

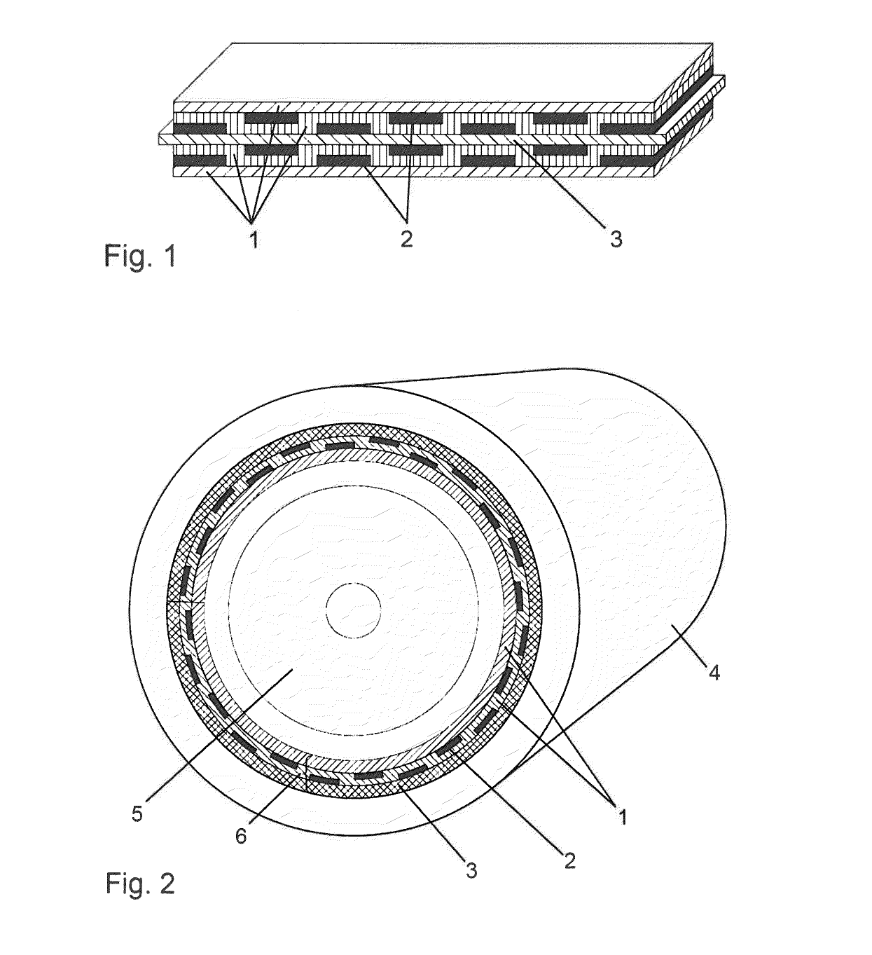

FIG. 1 shows the sectional view of a screen-printed winding. It comprises a carrier film 3 at the center consisting of a PET film having a thickness of 50 μm onto which the conductor paths 2 and a dielectric 1 are applied by means of a screen printing process. The material for the conductor paths 2 is an electrically conductive paste, the dielectric 1 is an insulating paste. To reduce the total thickness of the winding, the two layers of the conductor paths 2 are arranged in a shifted (offset) manner. For manufacturing the winding, the first layer of conductor paths 2 is first printed onto the carrier film 3 and then the first dielectric 1 layer, separating the first layer of conductor paths 2 from the second layer of conductor paths 2. The second layer of conductor paths 2 is disposed in a shifted manner, so that they are located above the gaps of the conductor paths of the first layer which are filled with dielectric 1. Finally, a further layer of dielectric 1 is printed on, which prevents electrical connection of superimposed layers of the winding in the wound state.

FIG. 2 shows a winding 6 printed on a single side, installed in a stator 4 and comprising a carrier film 3 and conductor paths 2 arranged in a shifted manner with layers of dielectric 1 arranged therebetween and on the outside. The electric energy converter comprises a rotor 5 in its interior.

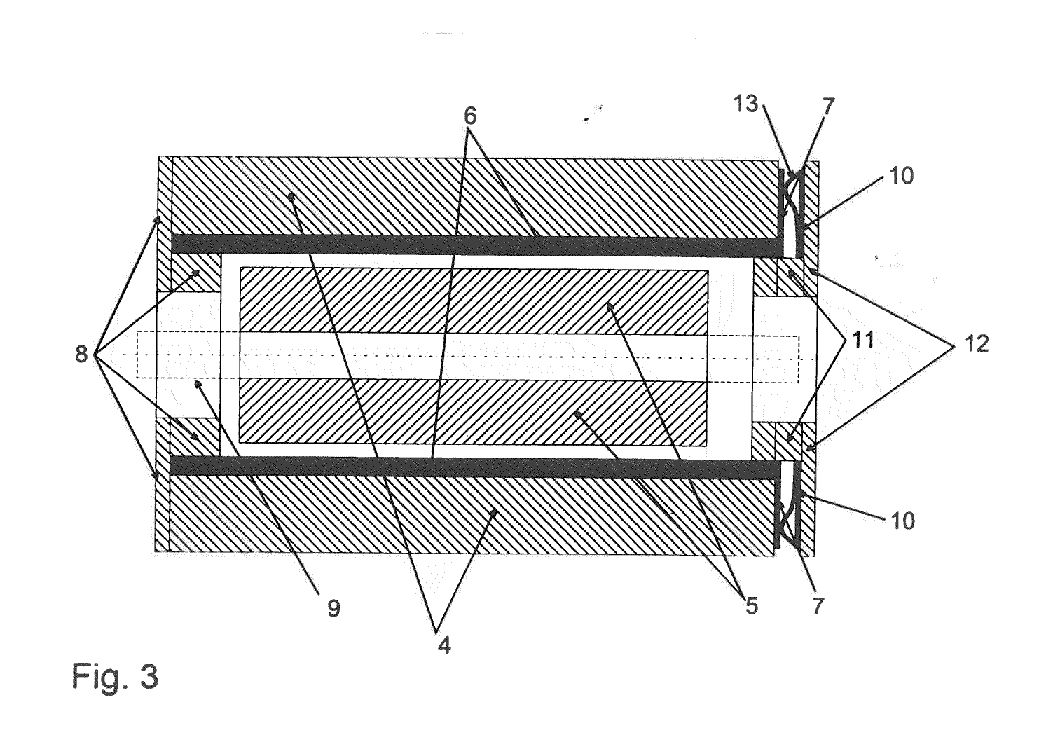

FIG. 3 shows a longitudinal section of the electric energy converter of FIG. 2. The rotor 5 comprises a bore at the center for a shaft 9. Furthermore, the stator 4 comprises stops for locking the winding 8 that secure the winding in its installed position. The winding 6 is inserted in the interior of the stator 4. At one axial end, the inserted winding 6 comprises contact tabs 7 which when installed are bent in the radial direction. A contact plate 12 comprises counter contacts 10 for contacting the contact tabs 7 of the winding 6. The counter contacts 10 comprise springy elements 13, which when installed press onto the contact tabs 13. Therefore, no soldering or other complex process is required for contacting. On the inside, the contact plate also comprises stops for locking 11 the winding 6. The winding 6 is thus locked on both sides.

Potentially, a one-sided affixation or backing of the position of winding can be sufficient or can be dispensed totally, in particular in conjunction with a bonding-based accommodation of the winding 6 at the stator 4.

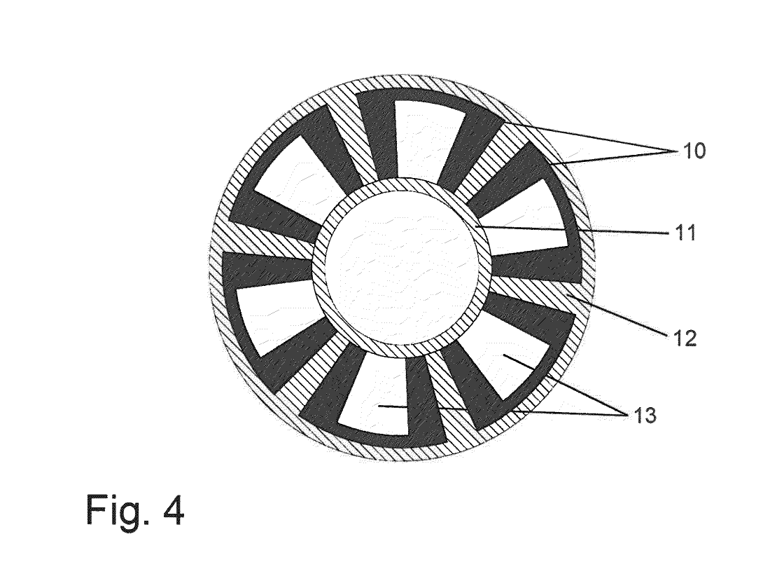

FIG. 4 shows a plan view of the inner side of the contact plate 12 with counter contacts 10 and springy elements 13 located thereupon.

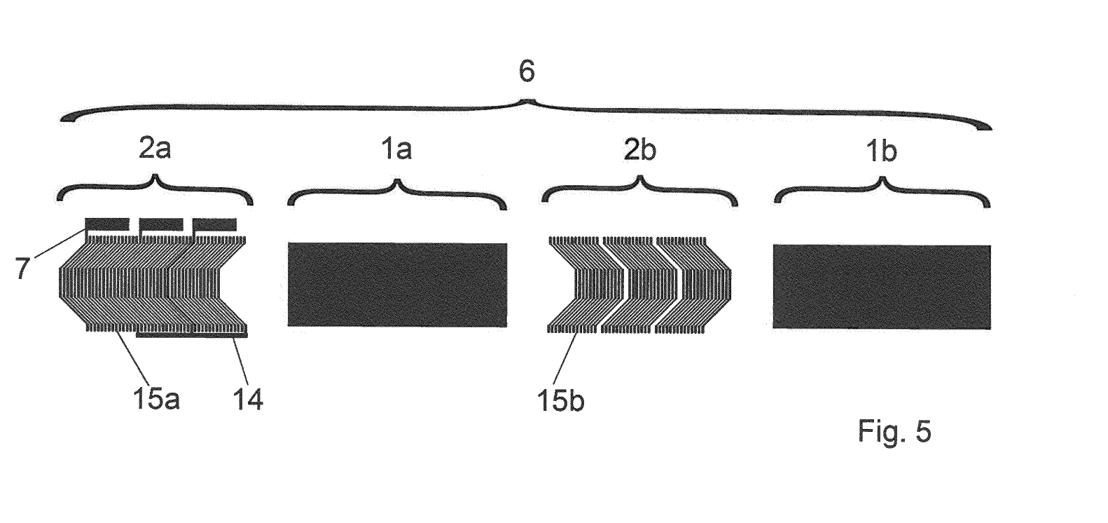

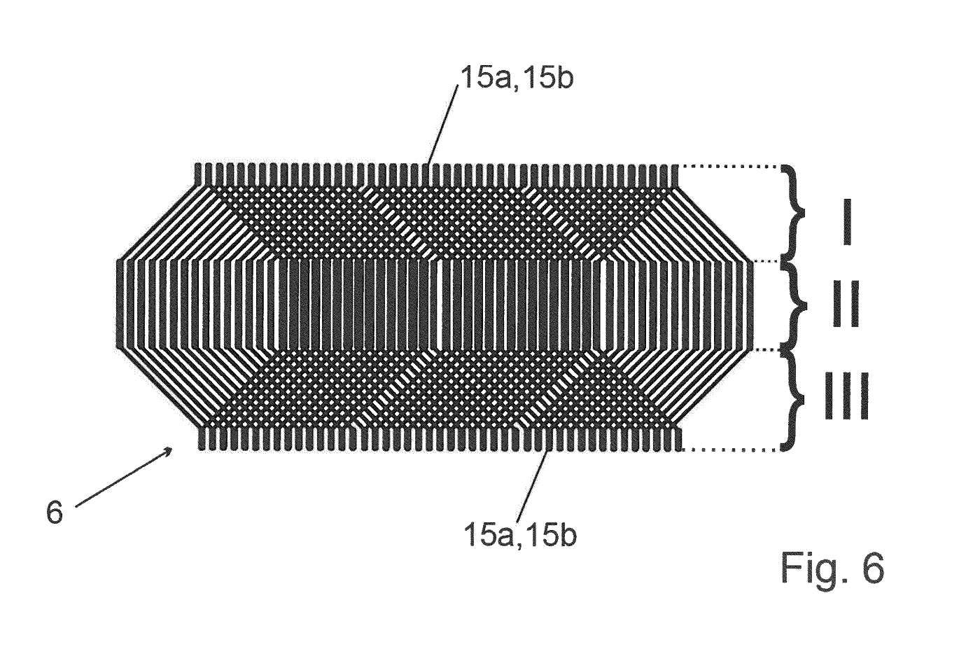

In FIG. 5 the layout of a screen printed winding 6 for electric energy converters is depicted in a schematic and expanded view for clarification of the rhombic structure of the winding and its single conductive paths 2 with a winding layer.

The winding 6 is practically implemented by printing in total four layers 1a, 1b and 2a, 2b. The layers 2a, 2b form electrically conductive winding layers. The layers 1a and 1b form insulating layers as dielectric, wherein the layer 2b forms an uppermost insulating layer as well as a protecting cover layer (see also FIG. 2). The conductive paths comprise a rhomb structure. First, the first winding layer 2a is printed, in particular screen printed, as supply conductors onto the carrier material (not shown). The supply conductors 2a comprise the contact tabs 7 as well as a printed star point 14 which solidly circuiting the machine. Onto these supply conductors 2a a layer of dielectric 1a is printed, in particular screen printed. It must be ensured in this case that the small winding head portions 15a of the supply conductors 2a (or of the first winding layer 2a, respectively) remain free, having preferably no contact with the layer of dielectric 1a. Subsequently, onto this layer of dielectric 1a, the return winding layer with the return conductors 2b are printed in such an arrangement that, their small winding head portions 15b exactly (only one winding conductor path offset) match the position of the small winding head portions 15a of the underlying supply conductors 2a to establish electrical contact with them. Lastly, the winding 6 and the return winding layer 2b printed most recently is finally covered (preferably screen printed) with a further layer of dielectric 1b which is predominantly intended to protect the winding 6 against mechanical wear.

Alternatively, the dielectric can also be jet-printed (jetter) onto the winding. When manufacturing the winding, the single layers preferably are dried intermediately or hardened (i.e. ultraviolet hardening) and/or the finished winding is subject to a hardening heat treatment. By means of that, the vaporization of the volatile organic constituents of the conductive paths and the electrical conductivity of the conductive paths increases. Preferably, the latter become galvanized in another intermediate step which also leads to a substantial reduction of the ohmic resistance.

For better visualization of the dielectric layers 1a, 1b and of the layers of the windings with the conductive paths 2a, 2b, same are exemplarily shown disposed adjacent to one another in FIG. 5 in expanded view. The first and third layer of the winding 6, forming the electrically conductive supply and return conductors 1a, 1b of the winding 6, are preferably printed with a silver paste and are arranged in a rhombus pattern, respectively. The necessary electrical connection between supply and return conductors 2a, 2b may—as in the illustrated solution—be realized by small winding head portions 15a, 15b projecting beyond the height of the interposed layer of dielectric 1a (cf. FIG. 6). But alternatively it can also be provided a recess in the layer of dielectric 1a, respectively, to establish an interlayer connection between supply conductor 2a and return conductor 2b by means of thought-contacting in the course of the imprinting of the second winding layer which is electrically conductive. Potentially, the winding can be composed of straight portions or of curved conductive paths or portions thereof which are shaped as involutes, ellipses or parabolas.

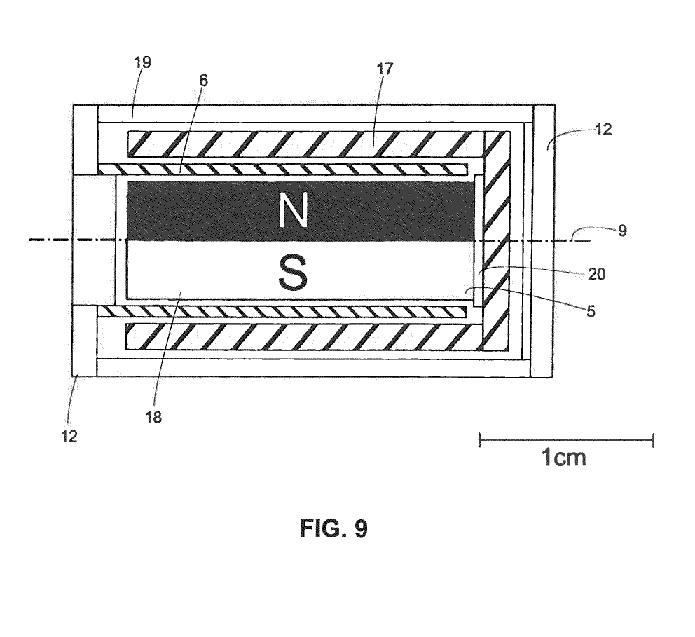

As shown schematically in FIG. 5, after printing the four layers on each other for a three-phased winding a complete screen printed three phase electric winding 6 is obtained which is exemplarily shown in FIG. 6 assuming the dielectric as transparent or omitted. Such a winding 6 can be applied in synchronous rotating electric motors or generators and is, for example, printed with a semi automatic screen printing machine with an optical positioning system. The figure clearly shows the planar honeycomb structure of the winding 6. This winding 6 is later on put on a core as an auxiliary jig in order to form a hollow cylinder of the winding connected in itself to form a self-carrying cylinder in order to be connected to a main component of the electrical machine (stator or rotor depending on purpose of usage) or to be disposed under maintenance of an air gap, i.e. to a permanent magnet on a rotor shaft and to a pot-shaped magnetic back iron also fixed to the rotor shaft to be fixed to the housing leaving a gap towards both sides and to be contacted at the end thereof (see FIG. 9).

The screen printed three phase air gap winding 6 of FIG. 6 is divided into three sub-machines I, II, III (conductive path sections), two skewed sub-machines I, III with inclined conductive paths and one non-skewed sub-machine II comprising straight conductive paths.

The before described winding embodiment is ideal for the manufacture of miniature and subminiature motors and can be manufactured economically with very low costs. Motors equipped with such windings 6 can, for example, be used in medical, aviation and space technology, as well as in the automotive sector, consumer goods industry and model construction.

By using, instead of conventional wire windings, printed windings, in particular screen printed windings 6 a much smaller geometry of the whole machine structure is reached. Nevertheless, similar ampere turns are obtained. The reason for this is the high current density of up to 100 A/mm² the printed, in particular screen printed windings 6 can be used with. What makes this possible is the favorable proportion of cross-sectional area in relation to surface that is responsible for a much better heat dissipation.

Another advantage of screen printed windings 6 is the reduction of construction volume for the end winding. It is possible to reduce its volume nearly completely.

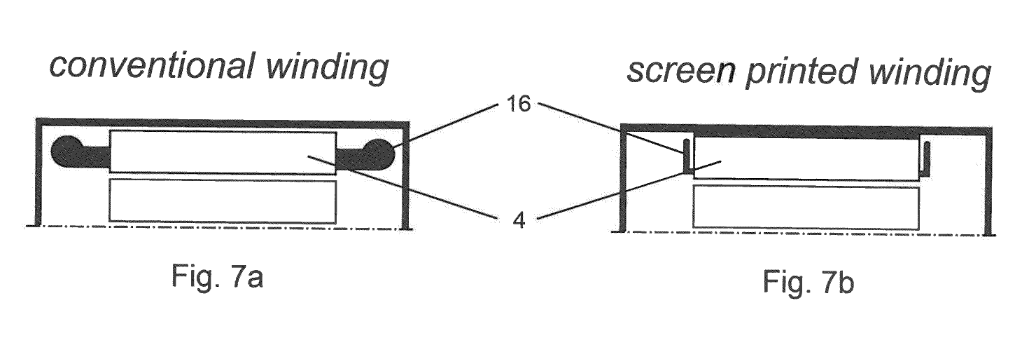

FIGS. 7a and 7b show the construction volume of the end windings of the different winding technologies. The clear unfilled rectangles represent the stator 4 whereas the winding head 16 surrounding the stator is shown in black (filled profile), respectively. It is immediately apparent that by using printed, in particular screen printed windings 6 it is possible to obtain a significant reduction of the necessary space for the winding head 16 when compared to conventional wire windings without pre-formed windings.

In 1838 the genetics-based variation and natural selection was found by Charles Robert Darwin in the biological sense. Over 100 years later, in 1956 George Friedman developed an algorithm based on natural selection as part of his master thesis. Therewith he constructed a machine to design electrical circuits in an automatic way. Though his work was largely theoretical, it forms an important basis for the use of such algorithms in the development of solutions to technical problems. Due to their simple solid construction genetic algorithms are mainly suitable to find a solution, where the structure of the problem is known little or the set of possible solutions is vast and very abstract. However, this simplicity and flexibility have the disadvantage that the best solution found is a very good approximation of the actual optimum. Especially with the winding design this is of minor importance, because the theoretical calculations are always subject to tolerances during the manufacturing process.

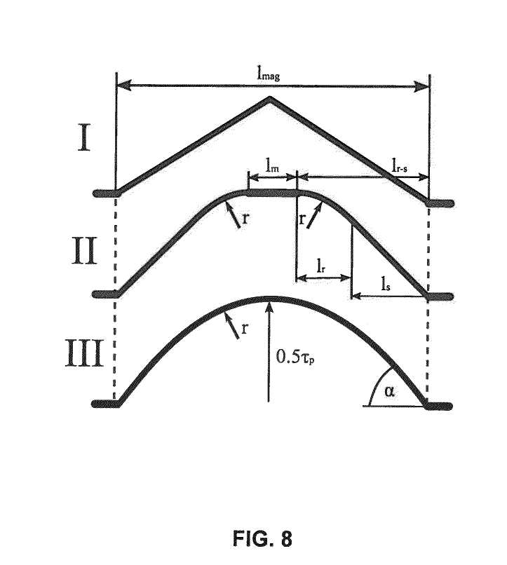

Applied to the geometry of a screen-printed windings using a genetic algorithm the following scenario can be described. Starting from the rhombic winding with its style similar to classic air-gap windings geometry, three technically feasible variations of the winding form arise within the windings, as shown in FIG. 8.

FIG. 8 shows representations of three possible geometrical variations of the principle layout of a rhomb structural winding for a 2D (two-dimensional) screen printing method, according to FIG. 6, having an additional straight conductor portion.

In FIG. 8, the expressions used have the following meaning:

l_{mag}: magnetic relevant length of the winding

lₘ: straight section of the diamond winding

r: radius

τₚ: pole pitch

lₛ: projected length of the straight part

lᵣ: projected length of the curve part

lᵣ₋ₛ: lₛ+lᵣ

α: angle between winding head and wire

All three alternatives I, II and III are independent of the number of windings under given flux density.

With the above explanations, the theoretical considerations for the design and performance of 2D screen printed electrical windings could be further strengthened and expanded. Starting from well-known winding geometries an improvement of the structure in terms of efficiency and the utilization factor was undertaken by means of genetic algorithms. The conflict in simultaneously improving ohmic resistance and utilization factor resp. torque must be considered here. Here a multi-step design process is recommended using different weights towards the end of a development setting a machine lengths l_{mag} for an inner diameter of the stator dᵢ which can be chosen. Varying the weighting changes the layout that is achieved is a valuable compromise whereas the result is in the range of a few percent change in length.

As a result, a confirmation of the intended layouts can be approved. Quite surprisingly it turns out that the inevitable beneficial straight section in the middle of the rhombic winding might be dropped in order to obtain a further improved layout.

Further parameter variations are possible. These mainly include the winding current, the maximum flux density in the air gap and the air gap length as such. These variables affect the size of the machine as a function of their thermal behavior. Accordingly, a separate thermal analysis is feasible to integrate the constraint of thermal loads into the winding design process.

FIG. 9 shows schematically in longitudinal cross-section a small electric motor in a pot structured rotor design with NdFeB-permanent magnet 18 which is a particularly useful structure. It comprises, for the excitation of the winding 6 a permanent magnet (NS) 18 which is affixed to a rotor shaft 9 (not shown in detail) together with the pot-shaped magnetic back iron 17 being also fixed to the rotor shaft 9 but being magnetically isolated from the permanent magnet 18 by a washer 20 made of plastic or synthetic resin in order to avoid a magnetic short circuit between the permanent magnet 18 and the magnetic back iron 17. The arrangement of such a pot structured rotor 5 with the winding 6 between with two air gaps, on the one hand, to the magnetic back iron 17 and, on the other hand, to the permanent magnet 18 on the rotor shaft 9, while being fixed and contacted at the housing side, comprises the practical avoidance of re-magnetization losses and a drastic reduction of detent torques so that the starting behavior of such a miniature motor is very much improved. Moreover, in view of the small thickness of the layers and the supporting foil for the winding 6, it is possible to use two of them in parallel within a machine so as to increase the performance thereof, while the factor of efficiency remains unchanged. In the construction shown in FIG. 9, the magnetic back iron 17, thus, is in standstill relative to the permanent magnet 18 both fixed to the rotor shaft 9 which leads to the afore-indicated advantages. The small increase in constructional volume is bearable for many applications to gain the advantage of avoiding re-magnetization losses and improvement of starting behavior.

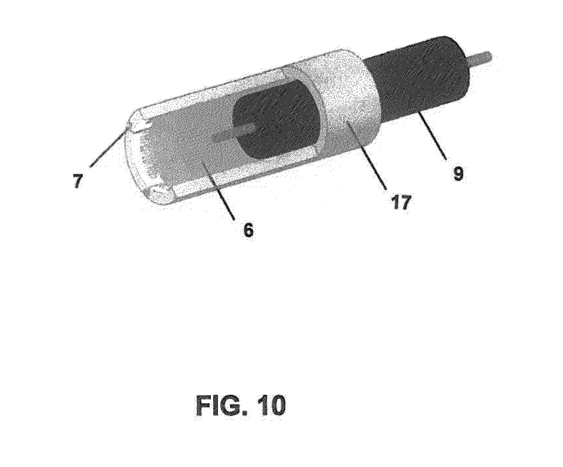

Accordingly, FIG. 9 in longitudinal section and FIG. 10 in perspective view shows schematically a special configuration of a small electric motor with magnetic back iron 17, same being fixed jointly with the permanent magnet 18 to a rotor shaft 9 (see FIG. 3) which is not shown in greater detail in FIG. 9 so as to establish a rotor 5, the permanent magnet 18 preferably being made of a NdFeB-magnet, whereas the magnetic back iron 17 is fixed to the rotor shaft under magnetic isolation from the permanent magnet 18 by means of a disk 20 made of synthetic resin or other plastic material, wherein the winding 6 is disposed as an air gap winding with a distance to both the magnetic back iron 17 as well as to the permanent magnet 18 which jointly form the rotor 5, while the air gap winding or coil 6 is affixed to a lid of the housing and a contact plate 12 of the housing 19, respectively, and is disposed stationary.

Such a design is advantageous in view of a cancellation of the re-magnetization losses of the exciting field (permanent magnet) within the magnetic back iron 17 (stator). Such a micromotor also shows a substantially improved starting behavior. The magnetic field created by the permanent magnets 18 of the rotor 5 here, closes via the magnetic back iron 17 (back of the stator), which is designed as a ferromagnetic element and is in rest relatively to the permanent magnet 18 as both form the rotor 5.

For increasing performance of such electrical micromachines, due to the minor thickness of the windings per machine, two windings can be used in parallel. Having a thickness of the flexible carrier film 3 of 50 μm and a layer thickness of the conductors of the winding or coil 6 including the dielectric, a total thickness of the printed winding or coil of about 160 μm can be obtained.

Thereinafter, a practical layout of an electric motor having a structure as shown in FIG. 9 can have the following dimensions:

length: 27 mm

diameter: 17 mm

electrical power: 1.8 W

nominal rotational speed: 10 000 rpm

efficiency: about 0.5

nominal torque: 0.8 mNm

When using ceramics as a carrier material and follow-up heat treatment under same dimensions, the following values are obtained:

electrical power: 3 W

nominal speed: 15 000 rmp

efficiency: about 0.7 to 0.8

nominal torque: 1.5 mNm

The geometry of the winding as such is designed equally in each layer and the number of turns and the number of layers can vary depending on the practical requirements of use and the acceptable or intended size of the electrical machine.

By using printed, in particular screen-printed windings, a much smaller geometry of the whole machine structure is achieved in comparison to conventional wire windings. Nonetheless, comparable total ampere-turns are obtained as a result of the high current density of up to 100 A/mm2 which are achievable by means of screen-printed windings 6. This is possible by means of the advantageous ratio of a cross-section to surface which leads to a much better heat dissipation. Another advantage of screen-printed windings in electrical machines is the drastic reduction of the construction volume of the end winding which can nearly completely be saved.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

The invention can advantageously be used in the area of rotating electrical machines and energy converters such as electrical motors and generators but also the area of resting stationary machines and transmitters, such as transformers and similar energy transmitting systems.

The present invention relates to a winding for electric energy converters such as electric machines, like electric motors, generators or transformers and to a respective winding. The winding has conductor paths applied to a flexible carrier material by means of a, in particular screen printing process. The conductor path consists preferably of an electrically conductive paste. The conductor paths are printed one above the other in layers, and an insulating layer is applied between individual layers of the conductor paths. The conductor paths are arranged such that the conductor paths of superimposed winding layers preferably are transversely shifted against each other in a pre-finished, rolled up state.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. Winding for electrical energy converter on the basis of electromagnetic force, said winding comprising conductor paths applied to a flexible carrier material by means of a printing process, in particular screen printing process, wherein the conductor paths are made of electrically conductive particulate or fluid material, in particular paste, such as a silver paste, and the conductor paths are printed in several superimposed layers, where an insulating layer is applied, preferably printed between the individual layers of the conductor paths.

2. Winding according to claim 1, wherein the winding comprises four layers printed on each other:
as first layer a supply conductor of the conductor path printed on the carrier material;
as second layer an insulating layer;
as third layer a return conductor of the conductor path; and
as fourth and final layer an insulating layer;
wherein the first and third layer are connected through an interlayer connection.

3. Winding according to claim 2, wherein said interlayer connection is realized through the connection of small winding head portions of supply conductor and return conductor, and wherein said small winding head portions project respectively beyond the interposed second layer having no contact to this layer.

4. Winding according to claim 1, wherein the conductor paths comprise contact tabs and/or a printed star point for a solid connection to a machine or sub-machine, wherein the contact tabs are provided at the axial beginnings and/or ends of the winding.

5. Winding according to claim 1, wherein the conductor paths are arranged in straight rows or in rhombus form, or in an involute, elliptical or parabolic shape.

6. Winding according to claim 1, wherein the carrier material (3) is imprinted on both upper/lower or outer/inner sides.

7. Winding according to claim 1, wherein the carrier material (3) is a film of plastic or synthetic resin, in particular thermoplastic material, e.g. PET, PEN, PEEK, or wherein the carrier material is made of ceramic material, for example, a ceramic foil, in particular the carrier material is formed as a prefabricated molding, for example, a sleeve.

8. Winding according to claim 1, wherein the conductor paths are arranged such that, when in a ready-to-install, rolled-up state, the conductor paths of the superimposed winding layers are transversely shifted against each other.

9. Winding according to claim 1, wherein parts of the control, evaluation, and power electronics necessary for operation are disposed on a joint flexible carrier material together with the electrical winding by means of screen printing methods.

10. Winding according to claim 1, wherein said winding is provided with a galvanic coating, for example, of copper.

11. Winding according to claim 1, wherein the carrier material forms a cylinder, at least along an interior surface or a part thereof, a plurality of conductive paths is printed in multi-layers alternating with layers of insulating material, preferably printed as well.

12. Electric energy converter on the basis of electro-magnetic force comprising a winding according to claim 1.

13. Electric energy converter according to claim 12, wherein contacting the winding is effected by contact tabs which are secured by means of a contact plate, wherein the contact plate comprises counter contacts having clamping or springy elements, and/or wherein the contact plate comprises at least one stop securing the radial and/or axial position of the winding.

14. Electric energy converter according to claim 12, wherein said electric energy converter is a small rotation drive device, in particular synchronous rotating electric motor or generator.

15. Electric energy converter according to claim 14, wherein the motor comprises a pot-shaped back iron and a permanent magnet, preferentially with NdFeB magnets, for excitation of the winding.

16. Method for manufacturing a winding for electric energy converters, such as DC or AC electric motors, electric generators or the like, comprising the following method steps:
a) calculating a required number of strands, the number of coils per shroud and a required conductor cross-section, respectively,
b) determining a winding geometry,
c) providing a carrier material for the winding and screens having a structure for providing conductive or insulating layers,
d) printing conductor paths or insulating layers onto the carrier material, and
e) drying and/or curing of layers,
f) repeating steps d) and e) until the desired number of conductor paths is applied.

17. Method according to claim 16, wherein a through-contacting is created between the individual conductor paths by specific recesses when printing the insulating layer, and/or further comprising galvanically coating the imprinted conductor paths with a metal coating, in particular a film of copper, and/or comprising applying a final, preferably controlled and regulated heat treatment to the winding.

18. Method for manufacturing a winding for electrical energy converters, comprising the following method steps:
a) printing the supply conductor of a conductor path on a carrier material,
b) printing a first insulating layer onto the supply conductor,
c) printing the return conductor of a conductor path onto the first insulating layer, and
d) printing a final second insulating layer onto the return conductor in order to protect the winding against mechanical wear.

19. Method according to claim 18, wherein at least one recess is formed in the first insulating layer such that when printing the return conductor on said first insulating layer, an electrical connection is made between the supply and return conductor, wherein the printing is preferably done by screen printing.

20. Method according to claim 18, wherein the printing is done by roll-to-roll printing the respective layers on at least part of the surface of a prefabricated mold, for example, a sleeve.

21. Method according to claim 18, wherein the printing is done by roll-to-roll printing the respective layers on at least part of the surface of a prefabricated mold, for example, a sleeve.

22. Method for installing a winding into an electric energy converter, comprising the following steps:
a) producing the required geometric shape of the winding,
b) securing the desired winding shape by means of direct positive-fit or force-fit methods or by indirect fixation by means of an apparatus corresponding to the shape of the main element carrying the winding, and
c) introducing the fixed winding into the main element carrying the winding, where the winding is secured in position by stops.

23. Electric machine comprising an energy converter according to claim 13.

24. Electric machine according to claim 20, comprising a rotor, wherein an electric winding is disposed between a permanent magnet forming the rotor and being affixed to a rotor shaft and a pot-shaped magnetic back iron affixed also onto the rotor shaft electrically isolated from the permanent magnet, wherein the winding is disposed with an air gap to the magnetic back iron and to the permanent magnet and is affixed to an end structure of a housing having an abutment and a contact section to the winding.
